(19) United States
(12) Patent Application Publication
(10) Pub. No.: US 2002/0109713 A1
(43) Pub. Date: Aug. 15, 2002

(54) Intelligent internet site method and system

(76) Inventors: Daniel Carchidi, Stamford, CT (US); Virginia Ertl, Stamford, CT (US); Peter Heller, Fairfield, CT (US)

Correspondence Address: Daniel F. Perez, Bickel & Brewer, 4800 Bank One Center, 1717 Main Street, Dallas, TX, 75201, US

(21) Appl. No.: 09/783,054

(22) Filed: Feb. 14, 2001

(51) Int. Cl. G09G 5/00

(52) U.S. Cl. 345/738

(57) ABSTRACT

A method and system for interactively organizing a web site for display within a computer network (80), wherein the computer network (80) has at least one client (92) connectable to one or more servers (88). A user is automatically guided through a predefined discovery path (104) leading to particular information objects. Such a predefined discovery path (104) is a guided discovery section (104) of a web site that permits users to explore processes with which they have limited experience. As users build their understanding of such processes, particular information objects (158, 162) may be deposited into a workspace (114) section of the web site as work-related destination objects (158, 162). The user is permitted to retrieve at least one particular information object (158) for use in organizing the web site displayed within the computer network (80), in response to completion of the predefined discovery path (104). Such a method and system, including program product implementations thereof, provides a customizable environment for the collection of destination objects (158, 162) that users interact with most often (188). By following the guided discovery path (104), users with limited understanding of a particular business process are permitted to explore key phrases, topics (148, 149, 140, 138), questions (150, 154, 142, 144), related questions, and destination objects that have been previously determined by content experts and business process experts.

### BACKGROUND

The development of computerized information resources, such as the “Internet,” and the proliferation of “Web” browsers, permit users of data-processing systems to link to other servers and networks, and thus retrieve vast amounts of electronic information heretofore unavailable in an electronic medium. Such electronic information generally is increasingly displacing more conventional means of information transmission, such as newspapers, magazines, and even television. As a result of this displacement, commercial enterprises and endeavors previously practiced only by conventional means of information transmission, are now being implemented and practiced via the “Internet” and “Web” browsers.

The term “Internet” is an abbreviation of “Internetwork,’ and refers to the collection of networks and gateways that utilize the TCP/IP suite of protocols, which are well known in the art of computer networking. TCP/IP is an acronym for “Transport Control Protocol/Interface Program,” a software protocol originally developed by the Department of Defense for communication between computers, but now primarily utilized as one of a number of standardized Internet communications protocols.

In the last decade of the 20^{th} century, explosive growth occurred in the use of the globally-linked network of computers now known as the “Internet.” In particular, the World Wide Web, or simply the “Web,” which facilitates the use of the Internet, has resulted in a revolution of electronic commerce and information transmission. The World Wide Web, well known in the Internet and computer networking arts, is generally composed of many pages or files of information distributed across a variety of computer servers and systems.

In order to utilize the World Wide Web, a client computer system runs a portion of software known as a graphical “Web” browser, such as Netscape Navigator or Internet Explorer. “Netscape” and “Navigator” are trademarks of the Netscape Communications Corporation, while “Internet Explorer” is a trademark of Microsoft. The client computer system interacts with the browser to select a particular Uniform Resource Locator (URL), by which each page is identified. The URL denotes both the server machine, and the particular file or page on that machine. Many pages or URLs may reside on a single server. The selection of the URL in turn causes the browser to send a request for that URL or page to the server identified in the URL. Typically the server responds to the request by retrieving the requested page, and transmits the data for that page back to the requesting computer system. This page can be then displayed for the user to view on the client screen. The client may also cause the server to launch an application, for example, to search World Wide Web “pages” relating to particular topics.

Most World Wide Web pages are formatted in accordance with a computer program written in a language known as HTML (hypertext mark-up language). This program contains the data to be displayed via the client's graphical browser as well as formatting commands which “tell” the browser how to display the data. Thus, a typical “Web” page includes text together with embedded formatting commands, referred to as “tags,” which can be utilized to control the font size, the font style (e.g., italic or bold), textual layout, and so forth. A Web browser “parses” the HTML script in order to display the text in accordance with the specified format. HTML tags are also utilized to indicate how graphics, audio, and video are manifested to the user via the client's browser.

The majority of Web pages also contain one or more references to other Web pages, which need not be on the same server as the original page. Such references may generally be activated by the user selecting particular locations on the screen, typically by clicking a mouse control button. These references or locations are known as hyperlinks, and are typically flagged by the browser in a particular manner (e.g., any text associated with a hyperlink may appear graphically in a different color). If a user selects the hyperlink, then the referenced page can be retrieved, thereby replacing the currently displayed page.

Commercial enterprises, organizations, and companies are actively utilizing the World Wide Web to initiate commerce. Several phases of electronic commerce via the World Wide Web have taken place. The first phase, namely publicity for companies and organizations, has already occurred. Homepages are commonplace, an essential ingredient for any company which wishes to maintain itself in line with current business practices. The publicity material posted electronically on company homepages contain marketing information, product brands, and in some cases, product catalogues.

The second phase, namely to conduct commerce, is generally emerging. Enterprises are poised to conduct business via the World Wide Web. They are seeking to make sales of their products and services, utilizing the World Wide Web. Software infrastructure is generally coming into existence to enable the progress of this trend. Secure financial protocols have been defined and are being implemented. The provision of firewall technologies offer safeguards to the enterprise, without which the enterprise would not contemplate permitting access to its critical data. Gateway products are becoming available to facilitate connection between the World Wide Web and server machines owned and operated by companies and commercial enterprises.

The third phase of commercial World Wide Web development, namely, the business-to-business arena, generally is only now being seriously implemented. Web business-to-business solutions require two components. First, a customer must be willing to engage in commercial transactions via the World Wide Web. Second, the company or enterprise expecting customer participation must offer and implement a secure and efficient electronic information delivery system.

One of the key difficulties encountered by companies, organizations, and individuals attempting to implement commercial operations through the Web/Internet is the problems inherent with developing a web site that supports particular organizational and business goals. Web development can be a slow and tedious process, particularly for those with little or no web design experience. Web development can also be a costly process, as many companies turn to outside contractors for web development efforts. Additionally, many web sites organize information topically, but have no connection to business process or work tasks, which can make it difficult for novice users to operate.

The ability to organize and develop a web site in a relatively easy and efficient manner, and also to do so in-house, rather than with expensive external assistance, would be a great benefit to any business or organization interested in web development. The present inventors thus realize that a solution to these problems lies in the formation of a web development tool, internet site, and associated methods and systems that can be easily utilized by business personnel in a cost-efficient, easy, and user-friendly manner. The invention disclosed herein meets this increasingly important need.

### SUMMARY

It is one aspect of the present invention to provide an interactive web-based site for a computer network.

It is another aspect of the present invention to provide a method and system for organizing web sites around key business processes based on the experience of content experts and business process experts.

It is still another aspect of the present invention to provide a guided discovery path including software module implementations thereof, for users who have limited understanding of particular business processes, and which permits such users to explore key phrases, topics, questions, related questions, and destination objects determined by content experts and business process experts.

It is yet another aspect of the present invention to provide a user interface in which a guided discovery path may function for user input and manipulation.

The above and other aspects of the present invention are achieved as is now described. A method and system for interactively organizing a web site for display within a computer network, wherein the computer network has at least one client connectable to one or more servers. A user is automatically guided through a predefined discovery path leading to particular information objects. Such a predefined discovery path is a guided discovery section of a web site that permits users to explore processes with which they have limited experience. As a user builds an understanding of such processes, information objects may be deposited as work-related destination objects into a workspace section of the web site. The user is permitted to retrieve at least one particular information object for use in organizing the web site displayed within the computer network, in response to completion of the predefined discovery path. Such a method and system, including program product implementations thereof, provides an environment for the collection of destination objects that users interact with most often. By following the guided discovery path, users with limited understanding of a particular business process are permitted to explore key phrases, topics, questions, related questions, and destination objects that have been previously determined by content experts and business process experts.

### BRIEF DESCRIPTION OF DRAWINGS

FIG. 1 illustrates a pictorial representation of a computer system, which may be utilized to implement a preferred embodiment of the present invention;

FIG. 2 depicts a representative hardware environment of a computer system in which a preferred embodiment of the present invention can be implemented;

FIG. 3 illustrates a block diagram illustrative of a client/server architecture, in accordance with a preferred embodiment of the present invention;

FIG. 4 depicts a detailed block diagram of a client/server architecture in accordance with a preferred embodiment of the present invention;

FIG. 5 illustrates a block diagram of a computer network in which a preferred embodiment of the present invention can be implemented;

FIG. 6 depicts a high level process diagram for Intelligent Internet Site development, in accordance with preferred embodiments of the present invention;

FIG. 7 illustrates a navigation structural diagram, in accordance with preferred embodiments of the present invention; and

FIG. 8 depicts a flow diagram illustrating Intelligent Internet Site development, in accordance with preferred embodiments of the present invention.

### DESCRIPTION OF PREFERRED EMBODIMENTS

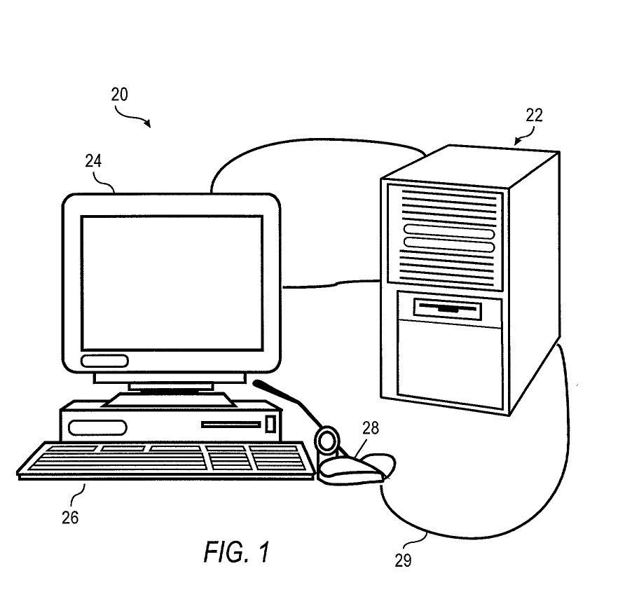

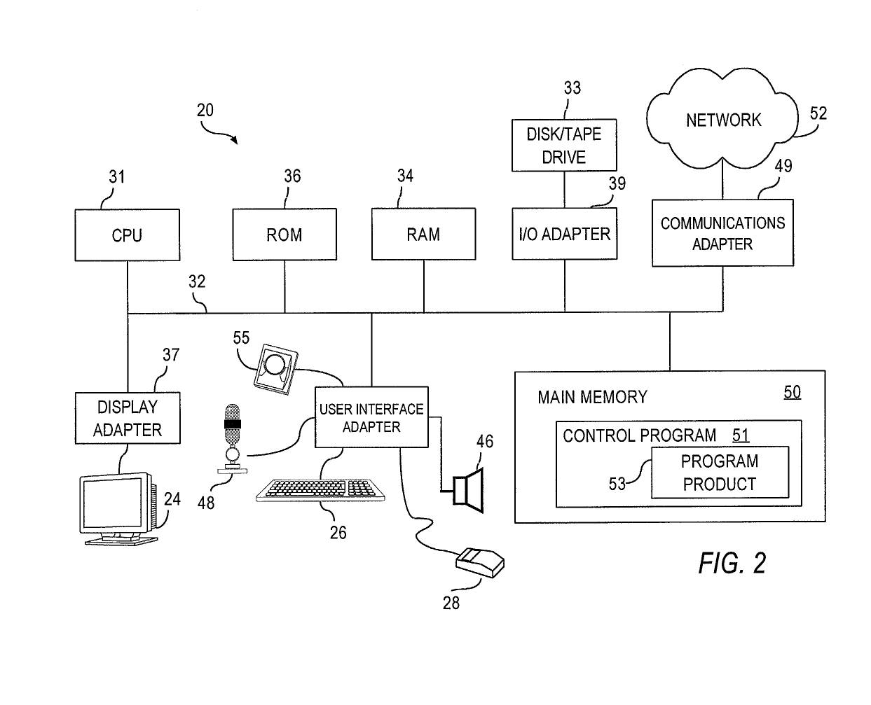

FIG. 1 illustrates a pictorial representation of a computer system 20, which may be utilized to implement a preferred embodiment of the present invention. Computer system 20 includes a system unit 22, a video display terminal 24, a keyboard 26, and a mouse 28. Those skilled in the art can appreciate that the method and system of the present invention apply equally to any computer system, regardless of whether the computer system is generally implemented as a complicated multi-user computing apparatus or a single-user workstation. In FIG. 1 and FIG. 2, like parts are identified by like numbers.

FIG. 2 depicts a representative hardware environment of the computer system of a preferred embodiment of the present invention. Computer system includes a Central Processing Unit (“CPU”) 31, such as a conventional microprocessor, and a number of other units interconnected via system bus 32. Such components and units of computer system 20 can be implemented in a system unit such as system unit 22 of FIG. 1. Computer system 20 further includes random-access memory (“RAM”) 34, read-only memory (“ROM”) 36, display adapter 37 for connecting system bus 32 to video display terminal 24, and I/O adapter 39 for connecting peripheral devices (e.g., disk and tape drives 33) to system bus 32.

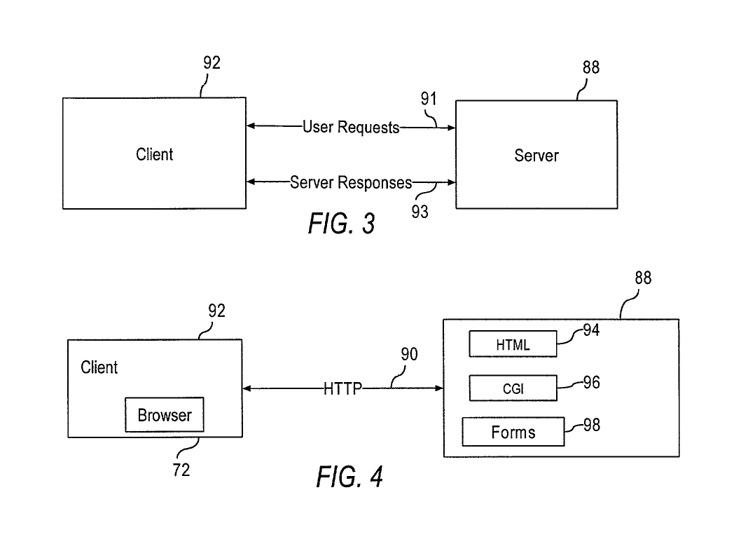

Video display terminal 24 generally provides the visual output of computer system 20. Video display terminal 24 can be implemental as a CRT-based video display, well known in the art of computer hardware. In the context of a portable or notebook-based computer, however, video display terminal 24 can be replaced with a gas plasma-based or LCD-based flat-panel display. Computer system 20 further includes user interface adapter 40 for connecting keyboard 26, mouse 28, speaker46, microphone 48, and/or other user interface devices, such as a touch-screen device (not shown) or a track-ball device 55 to system bus 32. Communications adapter 49 connects computer system 20 to a network 52, such as a computer network. Such a computer network may be implemented as, for example, the computer network configuration described herein with reference to FIGS. 3 to 5. Although computer system 20 may be shown to contain only a single CPU and a single system bus, it should be understood that the present invention applies equally to computer systems that have multiple CPUs and to computer systems that have multiple buses that each perform different functions in different ways.

Computer system 20 also includes an interface that resides within a machine-readable media to direct the operation of computer system 20. Any suitable machine-readable media may retain the interface, such as RAM 34, ROM 36, a magnetic diskette, magnetic tape, or optical disk (the last three being located in disk and tape drives 33). Any suitable operating system and associated interface (e.g., Microsoft Windows) may direct CPU 31. Other technologies also can be utilized in conjunction with CPU 31, such as touch-screen technology or human voice control. Those skilled in the art can appreciate that the hardware depicted in FIG. 2 may vary for specific applications. For example, other peripheral devices such as optical disk media, audio adapters, or chip programming devices, such as PAL or EPROM programming devices well-known in the art of computer hardware and the like, may be utilized in addition to or in place of the hardware already depicted.

Main memory 50 may be connected to system bus 32, and includes a control program 51. Control program 51 resides within main memory 50, and contains instructions that, when executed on CPU 31, carries out the operations depicted in the logic flow diagrams described herein. Control program 51 may be implemented as a program product 53, or may include software modules or functions based on program product 53. Such a program product may be implemented as, or may include, signal-bearing media such as recordable media and/or transmission media.

It is important to note that, while the present invention has been (and will continue to be) described in the context of a fully functional computer system, those skilled in the art can appreciate that the present invention may be capable of being distributed as a program product in a variety of forms. The present invention disclosed herein applies equally regardless of the particular type of signal-bearing media utilized to actually carry out the distribution. Examples of signal-bearing media include: recordable-type media, such as floppy disks, hard disk drives, and CD ROMs, and transmission-type media such as digital and analog communication links.

The program product itself may be compiled and processed as a module. In programming, a module may be typically organized as a collection of routines and data structures that perform a particular task or implements a particular abstract data type. Modules are typically composed of two portions, an interface and an implementation. The interface lists the constants, data types, variables, and routines that can be accessed by other routines or modules. The implementation may be private in that it is only accessible by the module. The implementation also contains source code that actually implements the routines in the module. Thus, a program product can be formed from a series of interconnected modules or instruction modules dedicated to working together to accomplish a particular task.

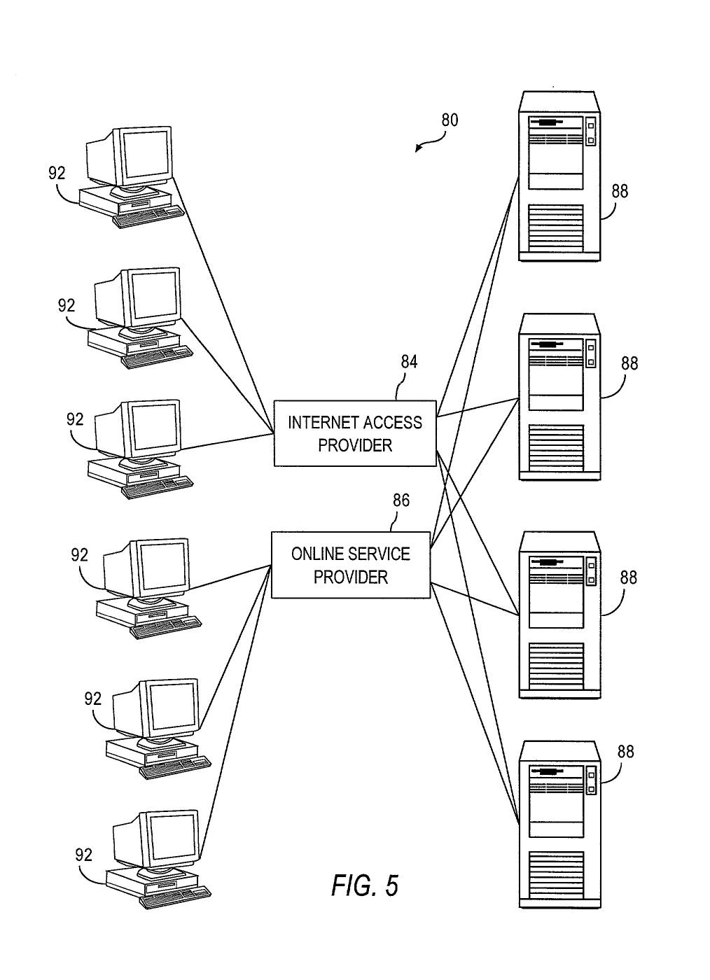

In FIG. 3, FIG. 4, and FIG. 5, like parts are indicated by like numbers. FIG. 3 illustrates a block diagram illustrative of a client/server architecture in accordance with a preferred embodiment of the present invention. In FIG. 3, user requests 91 for news are sent by a client application program 92 to a server 88. Server 88 can be a remote computer system accessible over the Internet or other communication networks. Client application program 92 may be utilized in association with computer 10 of FIG. 2 and the implementation of computer 10, as illustrated in FIG. 3.

Server 88 performs scanning and searching of raw (e.g., unprocessed) information sources (e.g., newswire feeds or news groups) and, based upon these user requests, presents the filtered electronic information as server responses 93 to the client process. The client process may be active in a first computer system, and the server process may be active in a second computer system, communicating with one another over a communications medium, thus providing distributed functionality and allowing multiple clients to take advantage of the information-gathering capabilities of the server.

FIG. 4 illustrates a detailed block diagram of a client/server architecture in accordance with a preferred embodiment of the present invention. Although the client and server are processes that are operative within two computer systems, these processes being generated from a high-level programming language (e.g., PERL), which may be interpreted and executed in a computer system at runtime (e.g., a workstation), it can be appreciated by one skilled in the art that they may be implemented in a variety of hardware devices, either programmed or dedicated.

Client 92 and server 88 communicate utilizing the functionality provided by HTTP. Active within client 92 is a first process, browser 72, which establishes connections with server 88, and presents information to the user. Any number of commercially or publicly available browsers can be utilized in various implementations in accordance with the preferred embodiment of the present invention. For example, browsers, such as Netscape™, can be utilized to provide the functionality specified under HTTP. “Netscape” is a trademark of Netscape, Inc. Microsoft Explorer may also be utilized to provide such HTTP functionality. “Microsoft Explorer” is a trademark of Microsoft Corporation.

Server 88 executes the corresponding server software, which presents information to the client in the form of HTTP responses 90. The HTTP responses 90 correspond with the web pages represented using HTML, or other data generated by server 88. Server 88 provides HTML 94. With certain browsers, a Common Gateway Interface (CGI) 96 may be also provided, which allows the client program to direct server 88 to commence execution of a specified program contained within server 88. This may include a search engine that scans received information in the server for presentation to the user controlling the client.

By utilizing this interface, and HTTP responses 90, server 88 may notify the client of the results of that execution upon completion. Common Gateway Interface (CGI) 96 may be one form of a gateway, a device utilized to connect dissimilar networks (i.e., networks utilizing different communications protocols) so that electronic information can be passed from one network to the other. Gateways transfer electronic information, converting such information to a form compatible with the protocols used by the second network for transport and delivery.

In order to control the parameters of the execution of this server-resident process, the client may direct the filling out of certain “forms” from the browser. This may be provided by the “fill-in-forms” functionality (i.e., forms 98), that may be provided by some browsers, such as the Netscape-brand browser described herein. This functionality allows the user via a client application program to specify terms in which the server causes an application program to function (e.g., terms or keywords contained in the types of stories/articles, which are of interest to the user). This functionality is an integral part of the search engine.

FIG. 5 is a diagram illustrative of a computer network 80, which can be implemented in accordance with a preferred embodiment of the present invention. Computer network 80 is generally representative of the Internet, which can be described as a known computer network based on the client-server model discussed herein. Conceptually, the Internet includes a large network of servers 88 that are accessible by clients 92, typically users of personal computers, through some private Internet access provider 84 (e.g., such as Internet America) or an on-line service provider 86 (e.g., such as America On-Line, Prodigy, Juno, and the like). Computer network 80 is one type of a remote computer network in which the present invention may be implemented. Those skilled in the art can appreciate that computer network 80 may also be implemented in association with wireless networks accessed by wireless remote devices, such as, for example, WAP (Wireless Application Protocol) enabled communication devices.

Each of the clients 92 may run a browser to access servers 88 via the access providers. Each server 88 operates a so-called “Web site” that supports files in the form of documents and web pages. A network path to servers 88 may be identified by a Uniform Resource Locator (URL) having a known syntax for defining a network collection. Computer network 80 can thus be considered a Web-based computer network.

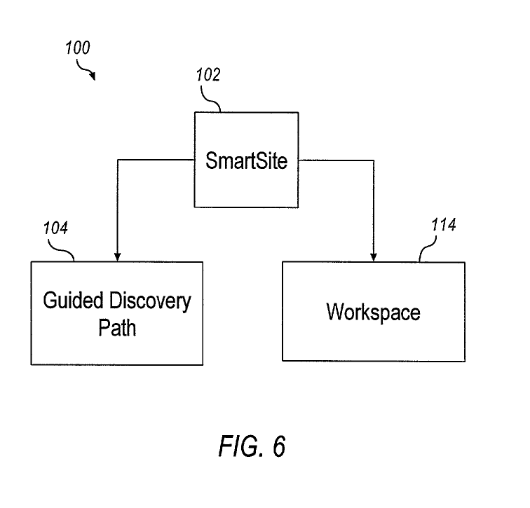

FIG. 6 depicts a high level process diagram 100 for Intelligent Internet Site development, in accordance with preferred embodiments of the present invention. Diagram 100 illustrates a process, expert-based approach to web site design and development. The process itself, including methods and systems thereof, can be referred to by the term “SmartSite.” Note that the term “SmartSite,” as utilized herein is merely an example term and is not a limiting feature of the present invention. Other terms may also be used to describe the method and system illustrated herein. Thus, a user accessing a web site which operates according to the methods and systems indicated herein may refer to such as web site as “SmartSite” or for example, a site based on Intelligent Internet Technology. By using SmartSite, users may be guided through a topic and question based interface that permits them to obtain tools, information and expertise quickly and accurately utilizing navigational paths designed by content experts and business process experts.

Many web sites are developed in a manner in which information is organized topically, but have little or no connection to business processes or work tasks. SmartSite utilizes the experience of content and business process experts to construct the navigation structure. Such a site can thus incorporate the behavior of experts to create a more efficient and effective web experience for both novice and experience users and designers.

Thus, as indicated in FIG. 6, a user can be faced with a web site 102 referred as SmartSite. A user can take advantage of web site 102 for web design purposes. Web site 102 is organized around key business processes originating in the experience of content experts and business process experts. Such features are implemented within the context of an interactive interface implemented within the web site. Web site 102 (i.e., SmartSite) can be generally organized as a group of related HTML documents and associated files, scripts and databases linked to an HTTP server on the World Wide Web. Such an HTTP server may be configured, for example, as server 88 of FIGS. 3, 4 and 5. Web site 102 may be displayed within a graphical user interface viewable through a client computer, such as client 92 illustrated in FIGS. 3, 4, and 5. The HTML documents contained by web site 102 generally may cover one or more related topics which are interconnected with one another through hyperlinks.

Thus, a user utilizing SmartSite as illustrated in FIG. 6 is faced with two possible facets of web development. First, a user can choose to follow a guided discovery path, as illustrated at block 104, which allows users with limited understand of a particular business process to explore key phrases and particular topics. The guided discovery path depicted at block 104 also permits users to explore questions (and related questions), and additionally, to explore destination objects that have been determined by company or organizational experts.

A second path that a SmartSite user may follow can be generally referred to as a workspace. Such a workspace may be configured as a section of the web site depicted as block 102 in which destination objects may be deposited Such destination objects are typically those objects that users interact with most often. Such a workspace is thus generally intended to provide quick access to information and tools for experienced users.

Those skilled in the web design arts can thus appreciate that SmartSite may be utilized to provide an efficient and intuitive method and system for organizing the web-based assets of a business around a common set of business processes. Such a site can provide users of varying experience levels with the opportunity to associate business processes and sub-processes with work task-related questions and destination objects. Users can thus gain experience and understanding of the business process through expert guided behaviors embedded within the website structure.

SmartSite assumes that few users can be experts in every business process contained within his or her business. The guided discovery section of SmartSite (i.e., see block 104) permits users to explore processes with which they have limited experience. As a user begins to develop understanding of such processes, work-related destination objects that they believe have become valuable to their increased understanding may be deposited into a workspace section (i.e., see block 114). Those skilled in the art can thus appreciate that the SmartSite approach can provide the right balance between expert guidance and user autonomy.

SmartSite has several other benefits, including the ability to provide answers to user questions at particular points of need, and the implementation of incidental learning through exploration of related questions. In addition, SmartSite provides content exploration strategies modeled on the experience of experts, and efficient knowledge and information acquisition based on user experience levels. SmartSite additionally provides an approach to knowledge and information acquisition that reinforces consistent processes across a particular business or organization that utilizes SmartSite, according to the methods and systems described herein.

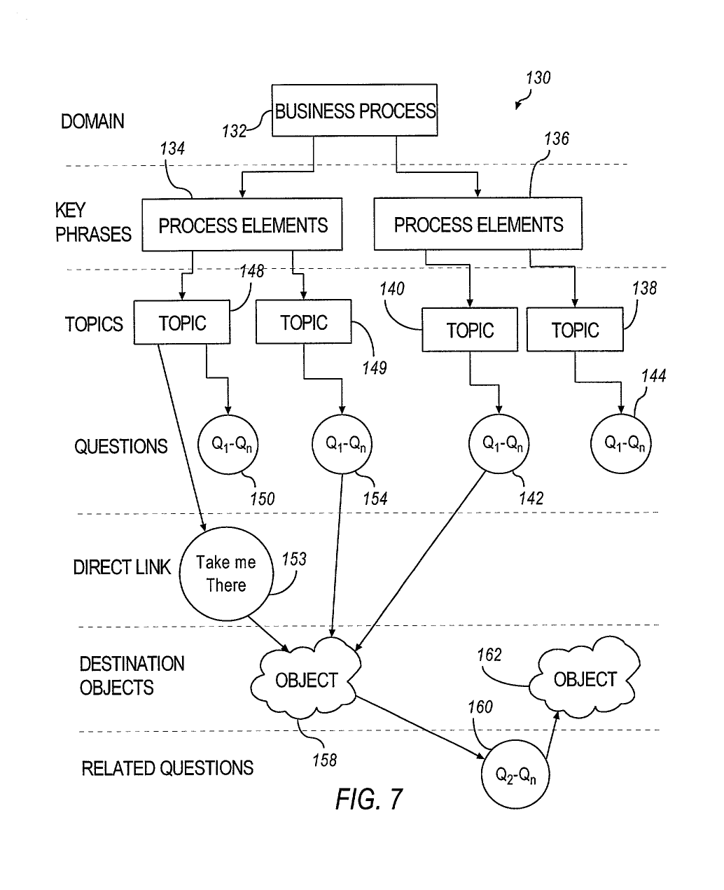

FIG. 7 illustrates a navigation structural diagram 130, in accordance with preferred embodiments of the present invention. As indicated at block 132, a business process may be designated for the domain. As utilized herein, the term “domain” generally refers to a discrete business process represented within a company or business. Process elements are indicated respectively at blocks 134 and 136 and are associated with key phrases. Through the guided discovery path discussed earlier, a user is enabled to explore key phrases. The user can then explore topics, as indicated respectively at blocks 148, 149 and 140, 138. Blocks 148 and 149 are branches of block 134 while blocks 140 and 138 are branches of block 136.

The user may then explore questions, as illustrated at blocks 150, 154 and 142, 144. The questions explored, as depicted at blocks 150 and 154 are respectively linked to the topics indicated at blocks 148 and 149. The questions explored, as illustrated at blocks 142 and 144 are respectively linked to the topics described at blocks 140 and 138.

A user may obtain a direct link to the destination object depicted at block 158 from, for example, the topic illustrated at block 148 through a direct high level link, illustrated at block 153. Such a direct high level link is referred to in FIG. 7 at block 153 as “Take Me There.” The user may also directly link from the question explored, as indicated at block 154, to the destination object illustrated at block 158. Additionally, a user may link from another question explored, as depicted at block 142, to the destination object described at block 158. Based on the process illustrated in FIG. 7, it can be appreciated that a work-related destination object, such as the object illustrated at block 158, that a user finds valuable, may be placed into a workspace. The object illustrated at block 158 may be further linked to a related question, as indicated at block 160, which in turn can be linked to another destination object, as indicated at block 162.

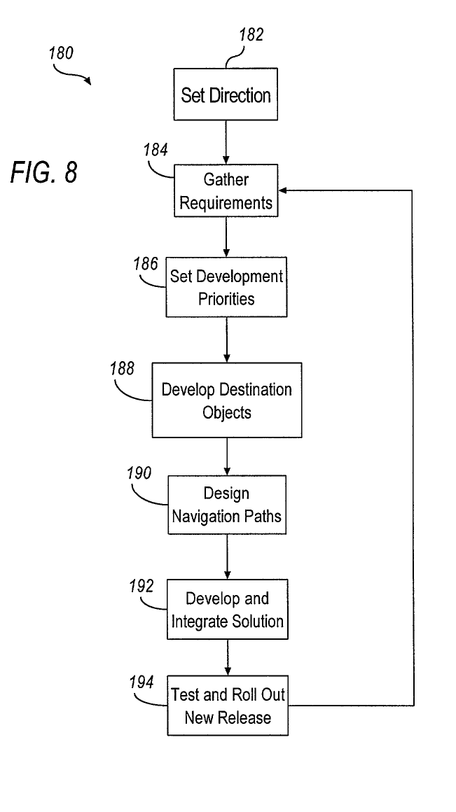

FIG. 8 depicts a flow diagram 180 illustrating Intelligent Internet Site (i.e., SmartSite) development tools, in accordance with preferred embodiments of the present invention. As illustrated at block 182, content managers generally set strategic direction for the domain. At this stage in the SmartSite development process, key topic areas are identified and a preliminary workplan is established. As indicated next at block 184, domain requirements are identified. Focus groups and interviews may be utilized during this stage to gather information. Thereafter, as depicted at block 188, development priorities are set. Destination objects are developed.

A narrowing of development efforts takes place at this stage, along with a setting of priorities and finalization of a workplan. As depicted next at block 190, navigation paths are designed. Content manager and appropriate staff may work together to develop navigation paths which will allow users to reach destination objects most effectively. Thereafter, as depicted at block 192, development and integration of a web-based solution takes place. At this stage in the design of a particular web site, destination objects are integrated with navigation path design. Unit tests may also be performed during this stage.

Finally, as indicated at block 194, the new web site may be tested and rolled out for operational use. At this stage, usability tests may be conducted and news releases made available to the public through an associated user database. The process may then be repeated, starting at block 184, thereby promoting continuous improvement of destination objects and navigation tools.

The embodiments and examples set forth herein are presented in order to best explain the present invention and its practical applications and to thereby enable those skilled in the art to make and utilize the invention. Those skilled in the art can recognize that the foregoing description and examples have been presented for the purposes of illustration and example only. Thus, the description as set forth herein is not intended to be exhaustive or to limit the invention to the precise form disclosed. Many modifications and variations are possible in light of the above teaching without departing from the spirit and scope of the following claims.

1. A method for interactively organizing a web site for display within a computer network, wherein said computer network has at least one client connectable to one or more servers, said method comprising the steps of:
automatically guiding a user through a predefined discovery path leading to particular information objects; and
permitting said user to retrieve at least one particular information object for use in organizing a web site displayed within said computer network, in response to completion of said predefined discovery path by said user.

2. The method of claim 1 wherein the step of automatically guiding a user through a predefined discovery path leading to particular information objects, further comprises the step of:
automatically guiding a user through a predefined discovery path that assists said user in exploring key phrases of interest to said user.

3. The method of claim 1 wherein the step of automatically guiding a user through a predefined discovery path leading to particular information objects, further comprises the step of:
automatically guiding a user through a predefined discovery path that assists said user in exploring topics of interest to said user.

4. The method of claim 1 wherein the step of automatically guiding a user through a predefined discovery path leading to particular information objects, further comprises the step of:
automatically guiding a user through a predefined discovery path that assists said user in exploring questions of interest to said user.

5. The method of claim 4 wherein the step of automatically guiding a user through a predefined discovery path leading to particular information objects, further comprises the step of:
automatically guiding a user through a predefined discovery path leading to particular information objects, wherein said predefined discovery path is interactively displayed for said user within a user interface at a client within said computer network.

6. The method of claim 4 wherein said customizable workspace comprises a workspace within said web site for the collection of particular information objects that users interact with most often.

7. The method of claim 1 wherein said at least one particular information object comprises a destination object.

8. The method of claim 7 further comprising the step of:
configuring said destination object based on content expert input.

9. The method of claim I wherein said guided discovery path permits users to explore processes with which that have limited experience to build understanding of such processes.

10. The method of claim 7 further comprising the step of:
configuring said destination object based on business expert process input.

11. A system for interactively organizing a web site for display within a computer network, wherein said computer network has at least one client connectable to one or more servers, said system comprising:
a predefined discovery path leading to particular information objects for use in organizing a web site displayed within said computer network; and
wherein said predefined discovery path can be interactively accessed by a user through a web site within said computer network.

12. The system of claim 11 wherein said predefined discovery path assists said user in exploring key phrases of interest to said user.

13. The system of claim 11 wherein said predefined discovery path assists said user in exploring topics of interest to said user.

14. The system of claim 11 wherein said predefined discovery path assists said user in exploring questions of interest to said user.

15. The system of claim 14 wherein said predefined discovery path is interactively displayed for said user within a user interface at a client within said computer network.

16. The system of claim 14 wherein said customizable workspace comprises a workspace within said web site for the collection of particular information objects that users interact with most often.

17. The system of claim 11 wherein said at least one particular information object comprises a destination object.

18. The system of claim 17 wherein said destination object is developed based on content expert input.

19. The system of claim 11 wherein said guided discovery path permits users to explore processes with which that have limited experience to build understanding of such processes.

20. The system of claim 17 wherein destination object is developed based on business process expert input.

21. A program product residing in computer memory in a computer for interactively organizing a web site for display within a computer network, wherein said computer network has at least one client connectable to one or more servers, said program product comprising:
a predefined discovery path leading to particular information objects for use in organizing a web site displayed within said computer network; and
wherein said predefined discovery path module can be interactively accessed by a user through a web site within said computer network.

22. The program product of claim 21 wherein said predefined discovery path module assists said user in exploring key phrases of interest to said user.

23. The program product of claim 21 wherein said predefined discovery path module assists said user in exploring topics of interest to said user.

24. The program product of claim 21 wherein said predefined discovery path module assists said user in exploring questions of interest to said user.

25. The program product of claim 24 wherein said predefined discovery path module is interactively displayed for said user within a user interface at a client within said computer network.

26. The program product of claim 24 wherein said customizable workspace comprises a workspace within said web site for the collection of particular information objects that users interact with most often.

27. The program product of claim 21 wherein said at least one particular information object comprises a destination object.

28. The program product of claim 21 wherein said destination object is developed based on content expert input.

29. The program product of claim 21 wherein said destination object is developed based on business process expert input.

30. The program product of claim 21 wherein said guided discovery path module permits users to explore processes with which that have limited experience to build understanding of such processes.

31. The program product of claim 21 wherein each of said modules comprise signal-bearing media.

32. The program product of claim 31 wherein said signal-bearing media comprises transmission media.

33. The program product of claim 31 wherein said signal-bearing media comprises recordable media.
